(19) United States
(12) Patent Application Publication
(10) Pub. No.: US 2010/0131134 A1
(43) Pub. Date: May 27, 2010

(54) Self Sustaining Electric Engine Enhancement (SSEEE)

(76) Inventor: David L. Wallace, Lakeland, FL (US)

Correspondence Address: David L. Wallace, 2512 Boots Road, Lakeland, FL, 33810, US

(21) Appl. No.: 12/276,828

(22) Filed: Nov. 24, 2008

(51) Int. Cl. B60W 10/08; H02J 7/00

(52) U.S. Cl. 701/22; 320/137; 320/128

(57) ABSTRACT

The Self-Sustaining Electric Engine Enhancement (SSEEE) specification modifies the process by which electric car engines consume and replenish electric power and dramatically extends the distance a car can travel before the need for pit stops to recharge the energy source, i.e., batteries, fuel cells, etc. It introduces a hot swappable configuration of battery/fuel cells to allow for quick exchange for a charged fuel source. It changes the process by which batteries or any fuel source is utilized. It introduces an intelligent device that controls access to batteries for both consumption and replenishment. It adds a charging device to the electric vehicle for a self-sustained power source. It eliminates the need in hybrid engines to have the entire engine be fueled by gas or biofuel—only the Charger(s) will be powered by gas/biofuel. Finally, it adds high availability and scalability enhancements to the existing electric car power processes to allow for continuous operations of the vehicle in the case of some component failures. It's a marriage of Information Technology and Electric Car paradigms.

### BACKGROUND OF THE INVENTION

This invention addresses Electric Car power and charging functionality. Existing electric car power replenishment processes require batteries or fuel cells be recharged at a type of service station or at home. This invention modifies that process by providing charging capability within the car itself and by changing the process by which batteries or fuel cells are utilized. It shifts the focus from requiring batteries run for longer periods of time prior to recharging at charging stations, to utilizing battery power more efficiently and utilizing charging capabilities built within the car. It takes advantage of newer battery technologies in which batteries can be recharged in a much shorter timeframe. In hybrid electric engines that utilize gas/biofuel until the batteries/fuel cells are recharged, this invention only requires that the charger device be powered by gas/biofuel and not the entire engine.

### BRIEF SUMMARY OF THE INVENTION

SSEEE adds two new components to existing electric engines: An Access Manager and a Charger. Additionally, SSEEE modifies how batteries or fuel cells are accessed and used. In hybrid electric engines, only the Charger component needs power from gas or biofuel. Finally, it adds built in component redundancy functionality. The term redundancy in this case means at least two or more of the same component.

The term batteries referenced herein, applies to any fuel source, such as batteries, fuel cells, etc. There are preferred battery technologies in existence today in the Lithium Ion and Lithium Polymer product families that can be recharged in a matter of minutes, but this process modification applies to any power source technology that can be used to power an electrical car.

### BRIEF DESCRIPTION OF THE DRAWINGS

FIG. 1 is a depiction of the existing electric power flow of the major components for both Direct Current and Alternating Current electric engines.

FIG. 2 is a depiction of the basic new enhancements added by this patient. It illustrates modifications to the process by which power is processed in an electric vehicle, as well as the logical placement of two new components (Access Manager and Charger) in the power flow process. It also depicts the Charger is the only portion of the electric engine that needs gas or biofuel as a fuel source.

FIG. 3 is an advanced depiction of optional redundancy additions to the electric car power-processing paradigm.

FIG. 4 depicts the composition of each individual cell in the array of batteries/fuel cells. It shows that each cell can be composed of multiple individual battery/fuel cells.

### DETAILED DESCRIPTION OF THE INVENTION

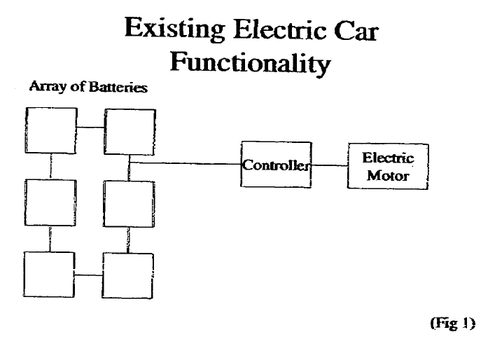

FIG. 1 is a depiction of the power flow of existing electric car engines. It illustrates that the existing power flow is for an Array of Batteries to supply power to the Electric Motor via a Controller. When the battery power is consumed, the batteries must be recharged for a period of time, making the car unusable while the batteries are being replenished.

This design specification contains four overall changes to the process by which existing electric cars are powered and how that power is replenished:
As with the current design, a group of batteries will be installed in each car, with the difference being, they will be used in an orderly and circular fashion, for both an energy source and a target to be charged
An ACCESS MANAGER intelligent computing device has been added that controls access to individual batteries for both the Controller and Charger.
A CHARGER device has been added to charge the batteries in an orderly and circular fashion, as they need replenishment. The Charger serves to charge batteries, fuel cells, etc. in the same way as an Alternator charges a battery in non-electric engines today.
The Charger is the only component of the electric engine that will utilize gas or biofuel as a fuel source.
The composition of each individual battery/fuel cell has been changed so that each individual battery/fuel cell can be a group of battery/fuel cells.

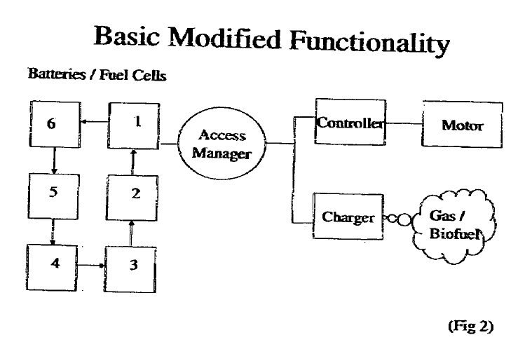

FIG. 2 depicts the modifications described above.

The goal of the basic modified functionality is a new process by which to consume battery power and replenish it, leading to a self-sustained electric car that doesn't require frequent charging pit stops as with existing electric cars.

Following are the specifics of how this process will work, based on the relationships between the parts illustrated in FIG. 2.

The Access Manager is the brain behind this new power consumption and replenishment process. It's a computerized device. It has two Primary functions: Access Grantor and Access Tester.
Access Grantor. Controls which battery the Controller and/or Charger will utilize at any given time. It keeps track of which battery was accessed last by both devices to ensure the right battery is either charged or used as an energy source.
Access Tester. Tests to ensure a battery is functioning properly prior to granting access. It can invoke a bypass/skip of a faulty battery.

As illustrated in FIG. 2, the Access Manager grants the Controller and Charger access to batteries in an orderly and circular fashion. Following is a description of how this process works:
a. Battery #1 is used by the Controller to power the Engine.
b. Once Battery #1 reaches a predetermined threshold, the Access Manager switches the Controller to utilize Battery #2.
c. The Access Manager then invokes the Charger to replenish Battery #1 while the Controller uses Battery #2 as a power source.

This above battery access process continues in a circular fashion, cycling the Controller and Charger through the batteries in a circular and orderly fashion.

Prior to granting access to either the Controller or Charger, the Access Manager initiates a test of the battery. If the battery fails the test, it's marked as faulty and will be bypassed until it is replaced or repaired.

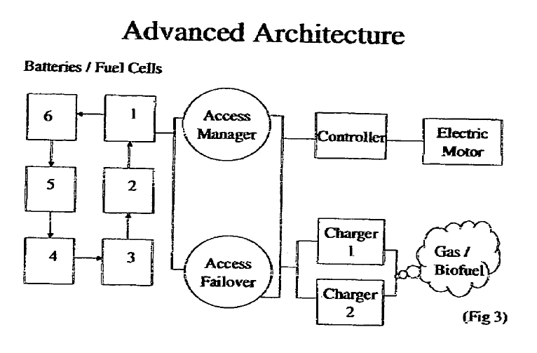

The functionality of this new power process design can be further extended to provide a highly scalable and fault tolerant design. FIG. 3 depicts this.

The advanced specification adds in a redundant Access Manager called an Access Failover device, along with one or more additional Charger devices.

The Access Manager Access Tester functionality of both the primary and failover Access Manager devices is extended in this configuration in the following ways:
The Tester functionality of both the primary and secondary Access Manager checks to ensure both Access Managers are functioning properly. They periodically send signals to each other and wait for acknowledgement from each other.
   If either device fails, an alert is sent.
   If the primary Access Manager fails, a failover is initiated to the Access Failover device.
   If the Access Manager is still operational and the Access Failover component fails, a notification alert is sent.

This advanced Access Manager configuration provides continuous operation of the vehicle upon failure and provides a grace period to get the failed Access Manager serviced or replaced.

Multiple Chargers can also be configured in an Active/Active configuration, meaning they can be engaged simultaneously. If the Controller is consuming battery power faster than a single Charger can replenish battery power, the Access Manager invokes the second Charger to work in parallel with the first Charger to simultaneously charge batteries. This process is managed in the follow way:
The Access Manager has switch the Controller from using Battery #2 to Battery #3.
Charger #1 is lagging behind, still charging Battery #1.
The Access Manager makes the decision, based on predetermined thresholds, to invoke Charger #2 to charge Battery #2.

Utilizing multiple Chargers to replenish batteries, minimizes the possibility of the Controller not having available battery power, because it has cycled through batteries faster then they can be replenished. If required, this functionality can be extended to include more than two Chargers. If one of the Chargers fails, the remaining Charger will supply replenishment capabilities by itself until the faulty Charger is replaced.

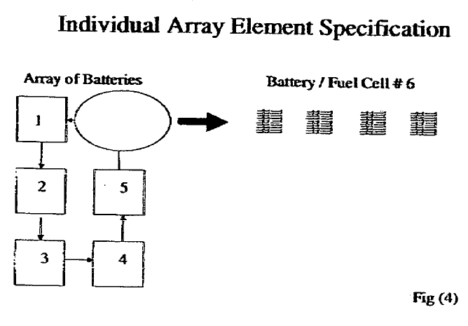

FIG. 4 depicts the composition of each element in the array of batteries. As the illustration shows, each element can be one or more batteries/fuel cells. Additionally, each element is hot swappable, meaning that each cell can be individually pulled out and replaced by a fully charged cell.

It should be further understood; this modification to the method by which an electric engine consumes and replenishes power is not limited by this description. Changes and modifications may be made to the specifics of the description above, without departing from the spirit of the invention and the scope of the claims.

What is claimed is:

1. Existing electric car functionality has three major components that power the electric vehicle. They are an Array of Batteries/Fuel Cells, a Controller and the Electric Engine. The Controller receives power from the batteries and uses that power to power the electric engine. This specification adds two new major components that work to power an electric vehicle. They are a computerized Access Manager and a Charger. The Access Manager grants access to the batteries/fuel cells, in a circular fashion, to the Controller for power consumption and to the new Charger device for power replenishment. The Controller no longer has direct access to the batteries as a fuel source.

2. As stated in claim 1, the batteries will be accessed in a circular fashion. Each battery is logically assigned a numeric value based on the port on the Access Manager to which it is attached. Meaning, if an Access Manager has six ports, with a battery attached to each port, the batteries would be numbered 1 through 6. The Access Manager grants access to individual batteries, in a circular fashion, starting with battery number 1, on through to battery number 6, and then starring again at battery number 1, providing continuous cycling through the batteries. The Access Manager can have more or less than 6 ports. In this case, 6 ports were selected to show the spirit and functionality of this new power processing and replenishment process.

3. As stated in claim 1, the new Access Manager computing device grants both the Controller and new Charger access to individual batteries in a circular fashion. The Assess Manager grants the Controller access to each battery/fuel cell in a circular fashion. After the Controller consumes a battery's power down to a predetermined threshold, the Access Manager switches the Controller's access to the next battery/fuel cell. The Access Manager then invokes the Charger to recharge the battery that was drained by the Controller. This process is continued in a circular fashion, allowing for extended driving distances of an electric vehicle. Only the Charger(s) will be powered by gas/biofuel.

4. Each element in the array of batteries can be one or more batteries/fuel cells. For example, in claim 2, there are 6 ports on the Access Manager, with each port attached to a battery/fuel cell that is part of the Array of Batteries. Each of those elements can also be an array of batteries. Additionally, each element is hot swappable, meaning that each element can be individually pulled out and replaced by a fully charged element.

5. Further enhancements, designed to implement component redundancy, is to install redundant copies of both the new Access Manager computing device and new Charger device in the electric vehicle. The first Access Manager device serves as the primary device utilized by the vehicle. The second Access Manager device serves in a failover capacity when the primary device fails. Each Access Manager has built in functionality to test each other and to send alerts if either of the devices fail. The multiple Charger devices will be used in an active/active manner, meaning multiple Chargers can simultaneously charge multiple batteries in the event a single Charger cannot keep pace with battery consumption by the Controller.

6. As stated in claim 5, in the advanced configuration, a pair of Access Managers can be installed. If the primary Access Manager fails, the secondary Access Manager will engage and keep the car operational until the primary Access Manager is repaired or replaced. This is an optionally add on configuration.

7. As stated in claim 5, in the advanced configuration, a pair of Chargers can be installed. If the first Charger falls behind on charging batteries (it's working at a rate slower than the Controller is draining batteries) then the Access Manager will engage the second Charger to assist with charging batteries. Additionally, if either of the Chargers fails, the other will continue to supply charging functionality until the failed charger is repaired or replaced. This design could be extended to comprise more than two chargers. This is also an optionally add on configuration.
